(19) United States
(12) Patent Application Publication
(10) Pub. No.: US 2010/0005518 A1
(43) Pub. Date: Jan. 7, 2010

(54) ASSIGNING ACCESS PRIVILEGES IN A SOCIAL NETWORK

(75) Inventors: Thomas M. Tirpak, Glenview, IL (US); Dennis T. Tsai, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/167,267

(22) Filed: Jul. 3, 2008

(51) Int. Cl. H04L 9/00; H04L 9/32

(52) U.S. Cl. 726/6; 726/3

(57) ABSTRACT

A system and method of assigning access privileges in a social network includes a first step (100) of determining a vector of social network characteristics of a member of the social network. A next step (102) includes computing a distance between vectors of social network characteristics of the member and other members of the social network already having defined access privileges. An optional next step (104) includes deciding whether the distance is less than a threshold. A next step (106) includes assigning the member the same access privilege of another member of the social network having the smallest distance from the vector of the member.

### TECHNICAL FIELD

This invention relates generally to communication networks, and more particularly to assigning access privileges between members of a social network.

### BACKGROUND ART

Today, people frequently communicate electronically with acquaintances through wired or wireless communication networks. Most forms of communication occur between groups of friends, family members, or co-workers. This type of group communication has given rise to social networking (e.g. LinkedIn™, Facebook™, etc.). As used herein, a social network is a social structure having a group of people that are linked together by one or more common links. These links may include friendship interdependency, familial ties, employment status, common likes, common dislikes, common subject matter interests, and so forth.

The members or participants of a social network are generally referred to as “nodes.” Each node is linked to another by a relationship or communication channel, often called a “tie” by which information is shared. Members of a social network may wish to restrict access to themselves and/or to content about themselves on the social network. As a result, the ability of one member to contact any other member in the social network or obtain content therefrom is controlled by access privileges.

One problem associated with access privileges in social networks is that there are scenarios where people want to be open to interaction with new users. However, they don't always have the time or knowledge to optimize the access level privileges before communicating with the new users. In this case, access level privileges are usually set too tight or too loose. In the former case, not enough information can be shared quickly, e.g., for volunteer emergency team work responding to a flood. In the latter case, too much sensitive information is shared. Therefore, other solutions have arisen to pre-assign access level privileges.

One solution to pre-assign access privileges has been to simply count the frequency of interactions between people with specific content items and then set access privileges for those items accordingly. However, in this solution, security is applied per content item, rather than per person, and it is difficult to establish good security for new (unknown) content items or new (unknown) users. In addition, the existing solutions consider connections but do not adequately consider a person's role in a Social Network, which is correlated with his/her need to access certain content/services.

Other solutions to the problem include: a) having no access restrictions, which may be appropriate for some but not all applications, b) manually providing a set of pre-configured security level profiles, and requiring a user to select one for each new user, which puts the burden/responsibility/liability totally on the device user, who may have limited knowledge about the new user and/or limited time to input detailed security settings for the new user, and c) performing a positive identification of the new user, e.g., via biometrics, and obtaining security level recommendations for this user from a trusted third-party service, which requires the existence of and highly-available connectivity to a third-party service to which user security level decisions are “outsourced”. However, this solution also presents opportunities for impostors to supply false counterfeit biometric data to the third-party service.

Accordingly, there is thus a need for an improved technique for assigning access privileges in a social network.

### BRIEF DESCRIPTION OF THE DRAWINGS

The accompanying figures, where like reference numerals refer to identical or functionally similar elements throughout the separate views and which together with the detailed description below, serve to further illustrate various embodiments and to explain various principles and advantages all in accordance with the present invention.

FIG. 1 illustrates a method in accordance with the present invention;

FIG. 2 is a diagram of social importance in accordance with the present invention;

FIG. 3 is a diagram of social network characteristics in accordance with the invention;

FIG. 4 is a flow diagram of a first use case in accordance with the present invention;

FIG. 5 is a flow diagram of a second use case in accordance with the present invention;

FIG. 6 is a flow diagram of a third use case in accordance with the present invention; and

FIG. 7 illustrates a simplified block diagram of a social network in accordance with the embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

The present invention provides an improved technique for assigning access privileges in a social network. In particular, the present invention provides a system and method of quickly identifying an appropriate security level setting (i.e. access level privilege) for a new (unknown) user, based on knowledge of her/his role in one or more Social Networks. All else being equal, users who have similar Social Network characteristics e.g., betweenness, centrality, closeness, etc., should have similar access level privileges to members, or content shared by members, of a Social Network.

Specifically, the present invention can assign or recommend access/security levels for users for whom there exists a social network characteristic, i.e. Social Network (SN) data, but of whom the given user has limited direct knowledge. As described below, the present invention gathers SN data, computes SN metrics, and computes similarity scores with respect to known users. The access privileges of the most similar known user (that meets a pre-defined similarity threshold) are subsequently assigned or recommended for the new (unknown) user. In one embodiment, there is the additional step of applying context-specific rules to further define the scope from the recommended access privileges. The present invention automatically identifies appropriate default security levels, which are periodically updated based on the changing role of someone in a Social Network, and allows a user to manually adjust the security levels per personal preference of that user.

In one embodiment, the determination of the social network characteristic is performed by a client-server type system. A server component observes client interaction or communication in one or more social networks. The client, which may be a mobile telephone, personal electronic device such as a portable music player, or personal digital assistant, has stored therein individual preferences. The client is capable of electronic communication with other client devices. The server component, in addition to being able to query the clients for the individual preferences, monitors the communication activity of each client to determine the social network characteristic of the client. The server component is then able to dynamically estimate the client's role in the social network for use in assigning or recommending access privileges for that client.

The server component can determine the individual's role in the social network by determining one or more social network characteristics of a member. These factors can include any one or more of: the “betweenness” of one or more members to other members of the social network; the “closeness” of the one or more members to the other members; the “centrality degree” of the one or more members relative to the other members; the “flow betweenness” centrality between the one or more members with the other members; the “eigenvector centrality” of the one or more members relative to the other members; the “centralization” of the one or more members; the “clustering coefficient” of the one or more members; the “cohesion” of the one or more members with the other members; the “density” corresponding to the one or more members relative to the social network; the “path length” of the one or more members with the other members; the “radiality” corresponding to the one or more members relative to the social network; the “reach” of the one or more members to the other members; the “structural cohesion” of the one or more members with the other members; the “structural equivalence” of the one or more members with the other members; or the “structural or static holes” in the social network. Each of these factors will be described in more detail below.

In addition, the server component can determine the role of each member of the social network by monitoring feedback from each member. Further, the server component may determine the role of each member of the social network by implicit analysis of each member's interaction with the network. Characteristics of interaction include each member's participation, access to content, recency of interaction, interaction frequency, and so forth.

Further, the server component gathers information about a user's Social Network and Social Network Analysis metrics for that user. For example, the server component may look at caller-callee history; query Social Networking sites in which the user is participating; the buddy list on the device; the white list-black list on the device or network service provider; and/or relationship information that the user himself/herself has entered. In addition, access privileges of existing user devices can also be gathered. Access privileges may either be stored on each client device or on the server component.

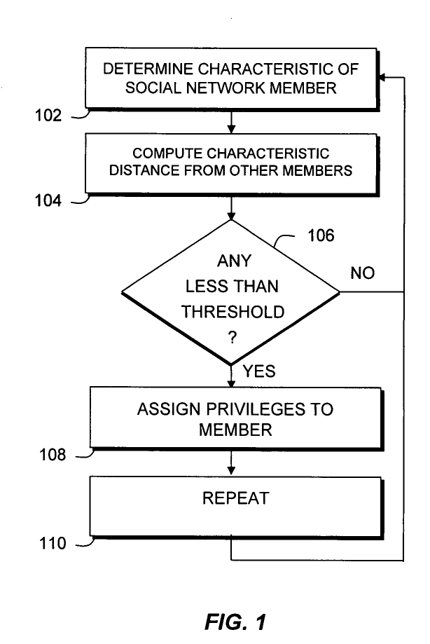

Turning now to FIG. 1, illustrated therein is one method of assigning access privileges in a social network, in accordance with the present invention. At step 102, at least one social network characteristic of a member of the social network is determined. The particular social network characteristic determined can be any of the characteristics described herein. Preferably, a vector of different social network characteristics is determined. A central server unit can have an interrogation module to obtain these characteristics by monitoring network communications or in response to a query to a member, such as a text message or other questionnaire transmitted by the server unit. Member push systems, query systems, or predetermined social network characteristic databases may be used to obtain individual member characteristics as well. The social network characteristics can also include context information, such as presence of specific members in the social network, shared location/time context, group membership, credentials, explicit restriction rules on a particular member, and explicit restriction rules for particular content.

The method then compares 104, 106 at least one social network characteristic to other members of the social network already having defined access privileges. This can be done in an analysis module of the server. In particular, the comparison computes 102 a distance between vectors of social network characteristics of the member and other known baseline members of the social network defined on the user's device and already having defined access privileges. Optionally, this step can include deciding 104 whether any distance is less than a threshold, thereby establishing a commonality between members for assigning the access privilege.

A next step 108 of the method includes assigning an access privilege to the member that is comparable to the access privileges of another member of the social network having the most similar at least one social network characteristic as the member. This can be accomplished by a privilege management module of the server, which is a software agent that recommends access level privileges for new members, based on their similarity in terms of social network characteristics to known members. If the vector distance is small enough, then the privilege management module recommends the same access level privilege as for that known other member. In particular, this step includes assigning the member the same access privilege of the other member of the social network having the smallest distance from the vector of the member. Optionally, this step can include recommending an access privilege to a user via a user interface and then prompting the user for any corrections to the recommended access privilege before finalizing the assignment. In this way, the method allows a user to manually adjust the access privilege per a personal preference of the user in order to more accurately reflect the desired level of access privilege. In particular, the privilege management module is operable to receive information from the user interface that provides a manual adjustment of the access privilege per the personal preference of a user. Upon reaching a decision about access privileges, the privilege management module modifies (automatically or with required user input) the access level privilege on the device and/or network.

A next step 110 of the method includes repeating the determining, comparing, and assigning steps to account for changes in the social network characteristic of the member. This repeating step can occur periodically or upon the occurrence of an event, such as a request for third party information about the member (e.g., an incoming call from a new user triggers a request to a third-party for information about the social network of that user), the termination of a call from the member (e.g., after a call from a new user is complete, then the device owner is asked “Analyze this new user and assign proper access level privileges? [Y/N]”), whenever new context data are available (e.g., the area code for a phone number has been input), and the addition of the member to a contact list.

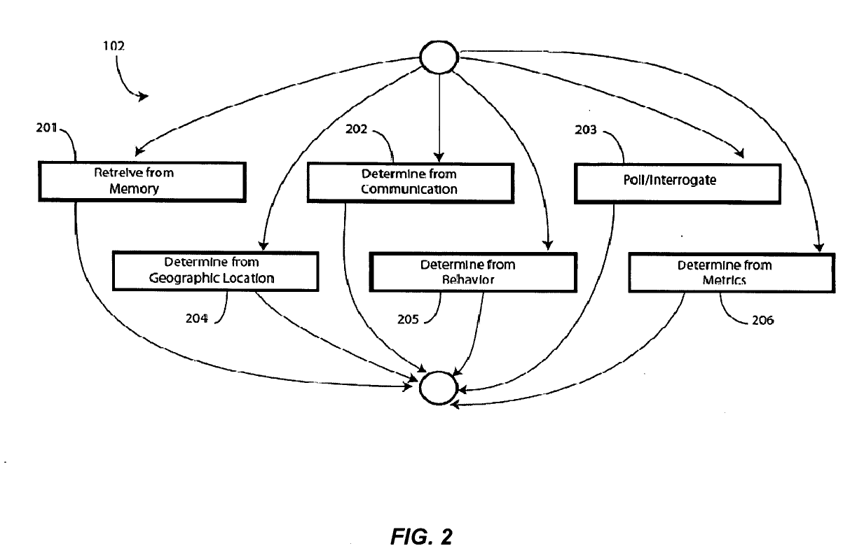

In a preferred embodiment, the determining step 102 determines the importance of each individual to the social network. This can be done in a variety of ways. Turning briefly to FIG. 2, illustrated therein are a few exemplary ways of performing the step 102 of determining the importance of each individual member to the overall social network.

At option 201, the importance of each member is determined by retrieving an importance list from memory. Said differently, the method (100) may determine each member's importance by retrieving predetermined importance data from memory. This list of members, ranked by importance to the social network, is then stored in memory. Such a list is then accessed to determine one measurement of each individual's importance to the network. For example, a member may define a relative importance to that member of other members, such a parent or spouse having higher importance than a friend or colleague.

At option 202, the importance of each member relative to the social network can be determined by monitoring the electronic communications of one or more members of the social network with other members. A central server can monitor communication between member's electronic devices. A member who sends forty text messages, for example, to other members is likely to be more important to the social network than a member who sends only one text message. Monitoring may be performed by either routing electronic communication through the central server, or by electronically monitoring peer-to-peer communication within the social network.

At option 203, the importance is determined by responses to polling questions. A central server interrogates one or more electronic devices belonging to the members of the social network to obtain the individual preferences. By way of example, the central server can send questions to the electronic devices of each member. One such question may be, “How many other members do you know?” Or, “How long have you known this member?” By carefully crafting the questions, answers may be used to determine the importance of each member to the social network.

At option 204, the importance is determined by the geographic location of each member of the social network relative to the network. Members who are more centrally located within the social network tend to be more important to the network than do members located on the periphery. By electronically monitoring the location of a portable electronic device or electronic identifier belonging to each member, one measurement of an individual's importance to a social network may be obtained.

At option 205, importance is determined by member behavior. In addition to communication frequency, certain member behavior may be indicative of a member's importance to the social network. By electronically monitoring electronic device activity of each member, such as the number of pictures or movies taken with a camera-enabled mobile telephone, one measurement of a member's importance to a social network may be obtained.

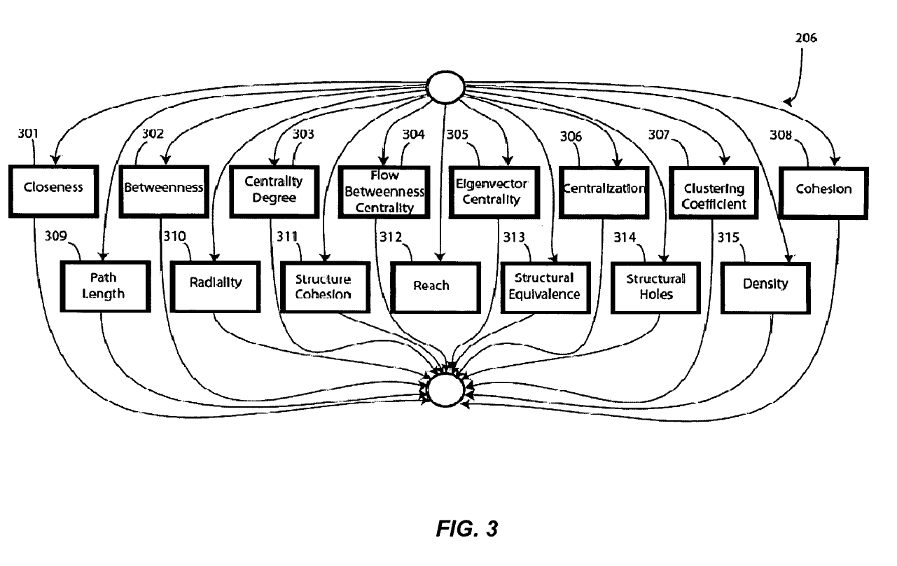

At option 206, social network characteristics or metrics can also be measured to determine a member's importance to the social network. Turning now to FIG. 3, illustrated therein are exemplary social network metrics that can be measured by monitoring member's electronic devices to complete option 206 in determining the importance of a member to a social network. Many of these metrics or characteristic can be measured by monitoring the electronic communication of each of the members, along with the message paths through which information travels.

The first metric 301 is that of closeness. Closeness is a measurement of the degree that one member of a social network is directly or indirectly near the other members of a social network. Such a metric may be measured, for instance, by monitoring the geographic location of an electronic device belonging to one member of the network relative to the geographic location of an electronic device belonging to another member. Closeness is an indicator of the ability of a member of the social network to access information through communication channels with other members. While all communication may not be electronic, the measure of closeness can be indicative of verbal and other forms of communication. One measure of closeness is the inverse sum of the shortest distances between each individual and every other member of the network.

The next metric 302 is that of betweenness. Betweenness is a measurement of the degree that a member is disposed between other members of the social network. Betweenness is also indicative of the extent to which a member has a channel of communication open directly with members that do not have channels of communication between each other. Betweenness is thus an indicator that a member serves as a liaison between members. Betweenness is also a measurement of the number of members a member has indirect communication channels to through their direct communication channels. Such a metric may be measured by monitoring the electronic communication trails of messages sent by each member of the social network.

The next metric 303 is that of centrality degree. Centrality degree is a measurement of the number of ties to other members of the social network. The concept of centrality degree was popularized by psychologist Stanley Milgram in a 1967 experiment that gave rise to the notion of “six degrees of separation” in human relationships. Centrality degree, which can be determined by monitoring electronic communication between members, measures how “connected” each member is to the other members of the social network.

The next metric 304 is that of flow betweenness centrality. Flow betweenness centrality is a measurement of the extent to which a member of a social network contributes to the flow of information between all members in the social network. Flow betweenness centrality may be determined by monitoring the electronic communication of each of the members of the network, along with the message paths that each piece of information takes.

The next metric 305 is that of eigenvector centrality. Eigenvector centrality assigns a quantitative ranking to each member of the social network based upon the communication channel connections each member has relative to other members. Known in the art of social networks, eigenvector centrality is a direct measurement of each member's importance to the social network.

The next metric 306 is that of centralization. Centralization is a measurement of a member's link dispersion about other members of the social network. Where the social network is based about a party, for example, many of the communication channels associated with the social network will be dispersed around one or two members, such as the host and hostess or bride and groom. The difference between the number of communication channels between each member, divided by the maximum possible sum of differences, is the centralization measurement.

The next metric 307 is that of the clustering coefficient. When relationships are not previously known, the clustering coefficient is a prediction of how likely any two members of a social network are directly linked—such as being friends or family members. By monitoring the frequency of electronic communication with any one other network member, a central computer can predict how likely to members are linked. Where a particular member has a high clustering coefficient with many other members, that member is likely to be more important to the social network than one who has a low clustering coefficient.

The next metric 308 is that of cohesion. Cohesion refers to a measurement of the direct connectedness of each member to other members of the social network. Known to those of ordinary skill in the art of social networks, cohesive bonds between a certain number of members is indicative of a sub-group of the social network. A member who has a high cohesion measurement with many sub-groups is likely to be more important to the social network than a member who is not affiliated with many sub-groups.

The next metric 309 is that of path length. Path length is simply a measurement of the distance between one member of the network to all the other members of the network. An invitee of the party who knows many attendees will have a shorter path length to the attendees than will a friend the invitee brings to the party who knows no one. As such, the invitee will typically be more important to the social network, as is indicated by the shorter path length, than will the friend who knows no one and thus has a longer path length to the other attendees (a path length that passes through the invitee).

The next metric 310 is that of radiality. Radiality is a measurement of an individual member's reach into the network for providing new information. By way of example, where a member initiates an electronic communication, such as “The chicken is delightful,” radiality measures how much that new information permeates the social network. A member offering higher radiality potential tends to be more important to the network.

The next metric 311 is that of structural cohesion. Structural cohesion is a measurement of the number of members of a social network that may cause the social network to disappear if they are removed from the social network. By way of example, where partygoers are attending a wedding reception, most all will disperse once the bride and groom leave the reception. Thus, the bride and groom exhibit a strong structural cohesion. High structural cohesion is indicative of high importance to a network.

The next metric 312 is that of reach. Reach is simply a measurement of the degree to which any member can communicate with other members of the social network. In short, reach is an indication of how many other members one particular member “knows.”

The next metric 313 is that of structural cohesion. Structural cohesion, known to those of ordinary skill in the art of social networks, is a measurement of common communication channel linkages shared by members of the social network. A higher structural cohesion measurement is indicative of greater importance to the social network.

The next metric 314 is that of structural holes. The concept of structural holes actually refers to the ability of a member in a social network to fill structural holes. A structural hole is a gap in communication channels. By filling a structural hole, perhaps by introducing two members, social network scientists hypothesize that the introducer has influence over the communication occurring within the newly made channel. Further, the ability to fill structural holes is indicative of the number of members that a particular member “knows.” As such, a member with the propensity to fill structural holes tends to be more important to a give social network.

The next metric 315 is that of density. Density is a measurement of a member's communication links as a proportion of the members of the network. Similar to centrality degree, density measures the proportion of communication channels existing in a social network relative to all possible communication channels. A higher measurement of density is indicative of a high importance to the social network.

Once the importance of the individual member to the social network is known, measured, or estimated, and the social network characteristics have been determined, an access privilege can then be assigned. The present invention envisions three different use cases for the present invention.

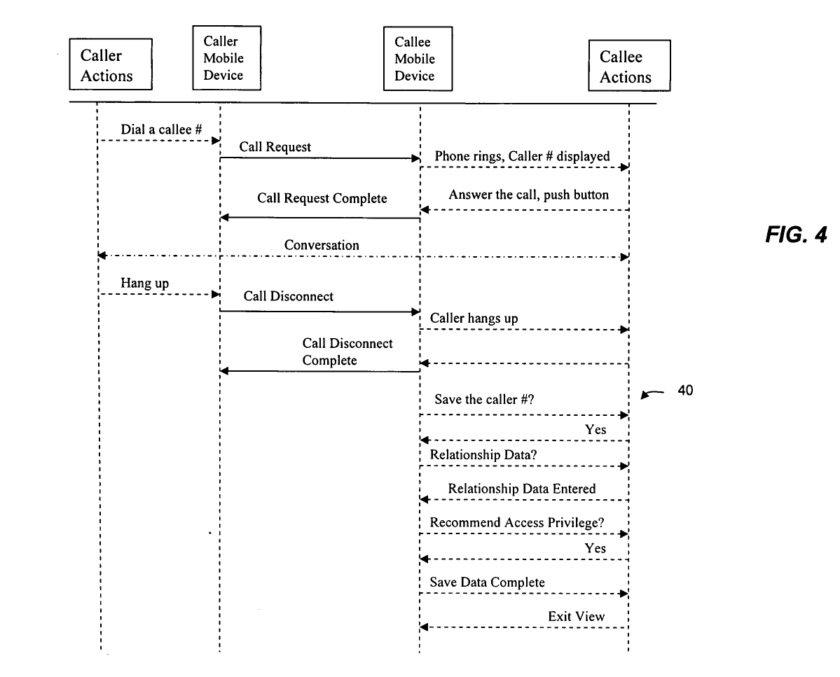

Referring to FIG. 4, a first use case stores a new caller number and setup for appropriate access privilege after a call completion. In this example, call to one of the members of the user's social network proceeds as normal until step 40, after the call has been completed. At this point, the called mobile device asks the user of the device to enter specific information about the caller to be stored on the callee mobile device. This stored information relates to access privileges for that particular caller, which would be applied the next time that the caller attempts to contact the callee. For example, the called mobile device outputs a question to the user of the device on the user interface asking the user whether to “Save the caller #”? The callee would then answer ‘Yes’ if the callee wishes to proceed to assign access privileges for that caller. Upon an affirmative reply, the callee mobile device can then ask about an importance of the caller (i.e. relationship data), which can be just having the callee select particular relationships from a predefined list or manually inputting a description of the particular relationship. The callee mobile device can then ask about access privileges for the caller, which can be just having the callee select a particular access privilege from a predefined list or manually inputting a particular access privilege, which can then be saved, whereupon the manual access privilege routine is exited.

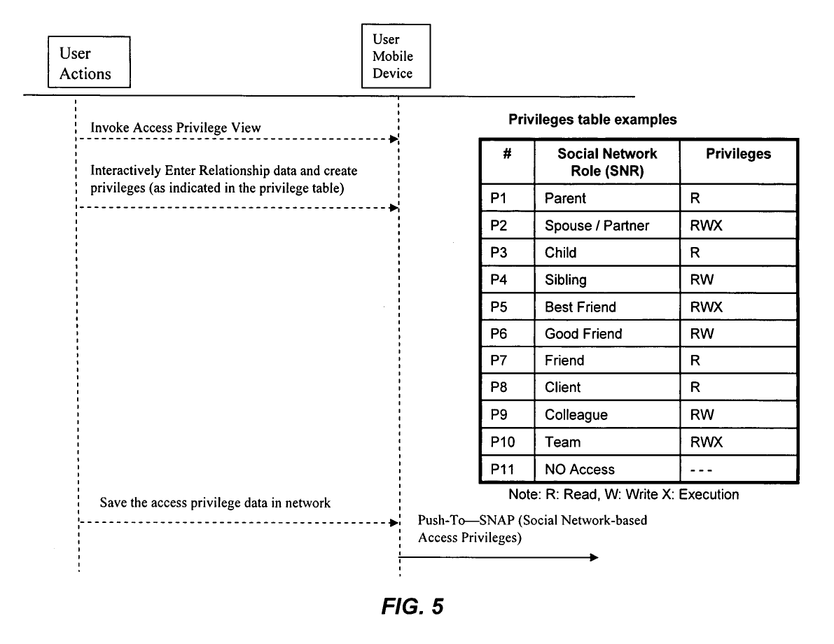

Referring to FIG. 5, a second use case provides a user setup and a technique to store user defined access privileges. In this case, a user can invoke an access privilege view on their mobile device, and interactively enter relationship data and access privileges as before, which can then be saved and further delivered to the network through a Push-to-SNAP (Social Network-based Access Privileges) operation. The diagram shows an example table of access privilege data which show relationships (e.g. parent, child) and associated access privileges (e.g. R-Read, W-Write, X-Execution).

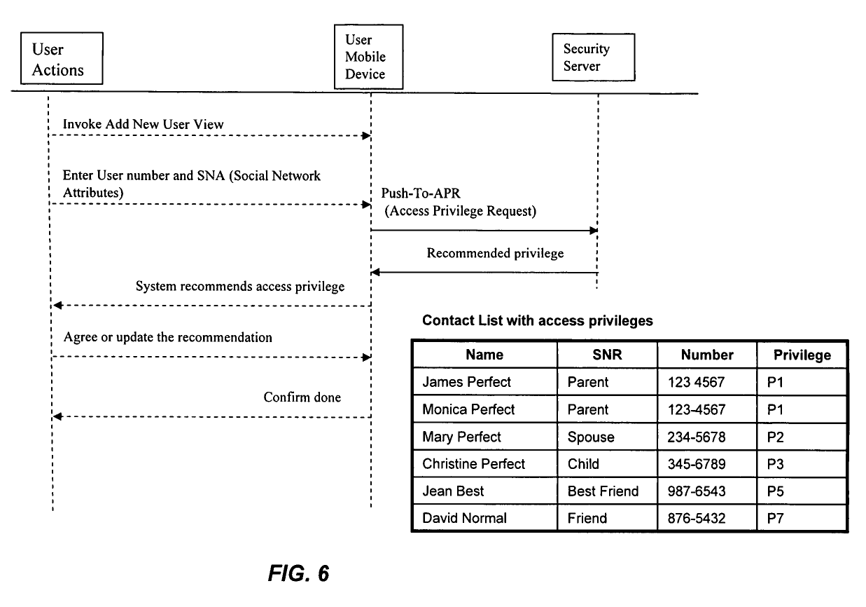

Referring to FIG. 6, a third use case illustrates a user adding new users to his/her contact list. In this case, a user can invoke a view to add a new user on his/her mobile device, and enter a user number along with social network attributes. At this point, the user device can invoke a Push-to-APR (Access Privilege Request) operation to a security server of the social network, which can then recommend an access privilege. The user can then accept or manually update the recommendation, which can then be saved on the mobile device. The diagram shows an example table of access privilege data show relationships (e.g. parent, child), phone numbers, and associated access privileges.

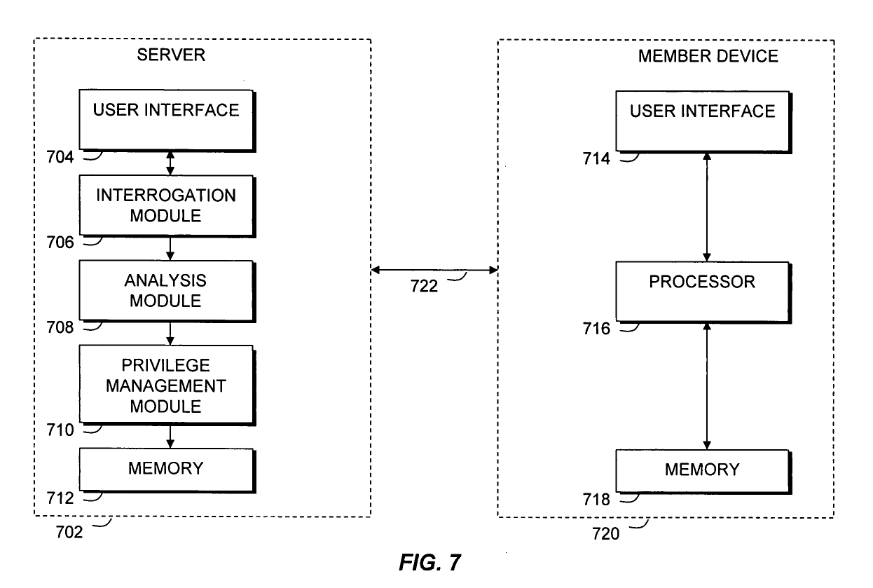

Turning now to FIG. 7, illustrated therein is a simplified hardware block diagram of social network including a server 702 and a plurality of network members 720 (one shown) for use in assigning access privileges in accordance with the invention. The diagram is intended to be illustrative only. Other configurations and devices suitable for use will be obvious to those of ordinary skill in the art having the benefit of this disclosure. Note also that not all components shown are necessary to practice embodiments of the invention.

A social network server 702, such as a central computer with associated memory 712, is capable of electronically coordinating communications between a plurality of electronic communication devices 720. Examples of suitable electronic communication devices include mobile telephones, pagers, computers, personal digital assistants, gaming devices, multimedia devices, and so forth. The server 702 communicates with the electronic communication devices 720, in one embodiment, across a network 722. The network may be a server-client type network, a peer-to-peer network, or other suitable communication networks.

The server 702 and member devices 720 include executable software for executing steps to assign access privileges. The use cases of FIGS. 4-6, for instance, may be coded into executable code operable with a processor of the server 702 and the member devices 720. As shown here the processor of the server is divided into three modules, an interrogation module 706, an analysis module 708, and a privilege management module 710, whereas the processor 716 of the member device 720 is shown as itself for the sake of simplicity.

The server 702, in one embodiment, includes access privileges for the plurality of social network members stored in memory 712. The server 702 is capable of retrieving and modifying the access privileges in the memory. Alternatively, each member device 720 can store access privileges for particular other member devices (i.e. buddy list) in its own memory 718. These access privileges may be directly sent to the server 702 from a member device for remote storage in the server memory 712.

The memory 718 of each member device may contain information relating to an individual's importance relative to a social network. For example, the memory may include membership status in various social networks. It may also include historical information, such as the date or time that the user joined the group, or the duration since the user started communicating with the group.

When used with embodiments of the present invention, the relevance of the social network can be transmitted to the server 702 by way of the communication network 722. The communication network 722 works to transmit not only the individual user's importance, but can also be used to determine the social network characteristics and context of communications of each member device 720.

Returning to FIG. 7, illustrated therein is one exemplary embodiment of a social network group in accordance with the present invention. An interrogation module 601 is configured to determine social network characteristics relating to the members of a social network. These social network characteristics can be obtained by many means. For example, observations of electronic communications between members of the network and interactions therebetween can be used to obtain social network characteristics. This is useful for new members to the social network. Alternatively, the social network characteristics of known members may be retrieved from a data base in the memory 712 of the server, or from each member device memory 718.

An analysis module 708 is configured to compare that social network characteristic of a new member to other members of the social network already having defined access privileges, which can be retrieved from memory as described above. If the social network characteristic of the new member is similar to a known member, then the access privileges of the known member can be provided as a default for the new member. Specifically, the analysis module 708 computes a distance between vectors of social network characteristics of the member and the other members, and decides whether the distance is less than a threshold, thereby establishing a commonality between members for assigning the access privilege by the privilege management module, which is then provided as a default for the new member.

Preferably, the default privilege is provided as only a recommended access privilege to either a server administrator or a member being called, wherein that user can accept or modify the access privilege. For example, a server administrator can review the recommended access privilege through a user interface 704 and modify the privilege to be stored in memory 712. In another example, a member device 720 being called by a new member can review the recommended access privilege determined by the server 702 through a user interface 714 and modify the privilege to be stored in memory (either 712 or 718).

A privilege management module 710 (or 716) is configured to assign an access privilege to the member that is comparable to the access privilege of another member of the social network having the most similar at least one social network characteristic as the member, or in response the user input through either user interface 704, 714, wherein the privilege management module is operable to receive information from the user interface that provides a manual adjustment of the access privilege per a personal preference of a user.

Advantageously, the present invention enables Role-based Dynamic Groups, where the groups (and corresponding access levels) are determined by users' dynamic roles within a Social Network. Other applications include communication tools for business users, to help them interact with both new and trusted clients, as well as their new and trusted suppliers. Additional applications are envisioned for individual users who like to interact with a lot of new people, but also have a trusted core group. For example, users can define content such that “part of me is public, part is of me semi-private, and part of me is private.” The proposed solution could be integrated in existing communication systems that manage call groups/buddy lists. For Push-to-X (PTX) applications, the proposed solution has the added benefit of reducing the latency of defining/obtaining access level settings for a new user who joins a communication group.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of assigning access privileges in a social network, the method comprising the steps of:
determining at least one social network characteristic of a member of the social network;
comparing the at least one social network characteristic to other members of the social network already having defined access privileges; and
assigning an access privilege to the member that is comparable to the access privilege of the other members of the social network having the most similar at least one social network characteristic as the member.

2. The method of claim 1, wherein the assigning step includes allowing a user to manually adjust the access privilege per a personal preference of the user.

3. The method of claim 1, further comprising the step of periodically repeating the determining, comparing, and assigning steps to account for changes in the social network characteristic of the member.

4. The method of claim 1, further comprising the step of repeating the determining, comparing, and assigning steps to account for changes in the social network characteristic of the member upon the occurrence of an event.

5. The method of claim 4, wherein the event is at least one of the group of; a request for third party information about the member, the termination of a call from the member, whenever new context data are available, and the addition of the member to a contact list.

6. The method of claim 1, wherein the comparing step includes the substeps of:
computing distances between a vector of social network characteristics of the member and vectors of social network characteristics of other members of the social network already having defined access privileges, and
deciding whether any distance is less than a threshold, thereby establishing a commonality between members for assigning the access privilege.

7. The method of claim 1, wherein the assigning step includes prompting a user for any corrections to a recommended access privilege.

8. The method of claim 1, wherein, in the step of determining, the at least one social network characteristic includes context information.

9. The method of claim 8, wherein the context information includes at least one of the group of; presence of specific members in the social network, shared location/time context, group membership, credentials, explicit restriction rules on a particular member, and explicit restriction rules for particular content.

10. The method of claim 1, wherein, in the step of determining, the at least one social network characteristic includes betweenness.

11. The method of assigning access privileges in a social network, the method comprising the steps of:
determining a vector of social network characteristics of a member of the social network;
computing distances between the vector of social network characteristics of the member and vectors of social network characteristics of other members of the social network already having defined access privileges;
deciding whether any distance is less than a threshold; and
assigning the member the same access privilege of the other member of the social network having the smallest distance from the vector of the member.

12. The method of claim 11, wherein the assigning step includes prompting a user for any corrections to a recommended access privilege.

13. The method of claim 11, wherein, in the step of determining, the social network characteristic includes context information.

14. The method of claim 1, wherein, in the step of determining, the vector of social network characteristics includes betweenness

15. A system for assigning access privileges in a social network, the system comprising:
an interrogation module configured to determine at least one social network characteristic of a member of the social network;
an analysis module compare that at least one social network characteristic to other members of the social network already having defined access privileges; and
a privilege management module configured to assign an access privilege to the member that is comparable to the access privilege of another member of the social network having the most similar at least one social network characteristic as the member.

16. The system of claim 15, further comprising a user interface, wherein the privilege management module is operable to receive information from the user interface that provides a manual adjustment of the access privilege per a personal preference of a user.

17. The system of claim 15, wherein the analysis module computes a distance between vectors of social network characteristics of the member and the other members, and decides whether the distance is less than a threshold, thereby establishing a commonality between members for assigning the access privilege by the privilege management module.

18. The system of claim 15, wherein the at least one social network characteristic includes context information.

19. The system of claim 15, wherein the at least one social network characteristic includes betweenness.
